(19) United States
(12) Patent Application Publication
(10) Pub. No.: US 2017/0221155 A1
(43) Pub. Date: Aug. 3, 2017

(54) PRESENTING ARTIST-AUTHORED MESSAGES DIRECTLY TO USERS VIA A CONTENT SYSTEM

(71) Applicant: Pandora Media, Inc., Oakland, CA (US)

(72) Inventors: Adam Zabarsky, Berkeley, CA (US); J.J. Schultz, San Francisco, CA (US); Chris Phillips, Berkeley, CA (US); Michael Dorsey, Oakland, CA (US); Jonathan Yu, San Francisco, CA (US); Carrie Burgener, San Francisco, CA (US); Phillip Vanderveer, Livermore (CA); Marc Novakowski, Kelowna (CA); Kevin Kaiser, San Francisco, CA (US); Jennifer Mendez, Berkeley, CA (US)

(21) Appl. No.: 15/011,387

(22) Filed: Jan. 29, 2016

(51) Int. Cl. G06Q 50/00

(52) U.S. Cl. CPC G06Q 50/01

(57) ABSTRACT

A content server receives artist messages from client devices of artists, each artist message including content created using the client device of the respective artist. The content server receives from a client device of a listener a request for media items, the request including a seed value. The content server provides media items selected based on the seed value to the client device of the listener. The content server identifies a subset of the artist messages as eligible artist messages for the listener based on the media items provided to the client device of the listener. The content server scores the eligible artist messages based on a relevance of the message to a listener, and selects an eligible artist messages based on the scores. The content server provides the selected artist message to the listener.

### BACKGROUND

Field of Disclosure

The present invention generally relates to the delivery of content, and more specifically to ways of presenting artist authored messages directly to users via a content system.

Description of the Related Art

Many users utilize their digital devices to consume media content. For example, a user may use a media application on her digital device to play a media item (e.g., a song) from a content server. The artist that created the media item may wish to communicate directly with the users who are consuming it. However that artist cannot directly communicate with the users through the media application.

### SUMMARY

The above and other needs are met by a computer-implemented method, a non-transitory computer-readable storage medium storing executable code, and a device for presenting artist authored messages directly to users via a content system.

One embodiment of the computer-implemented method for providing artist messages to listeners, comprises receiving a plurality of artist messages from client devices of a plurality of artists, each artist message including content created using the client device of the respective artist; receiving from a client device of a listener a request for media items, the request including a seed value; providing media items selected based on the seed value to the client device of the listener; identifying a subset of the plurality of artist messages as eligible artist messages for the listener based on the media items provided to the client device of the listener; scoring the eligible artist messages based on a relevance of the message to the listener; selecting an eligible artist messages based on the scores; and providing the selected artist message to the client device of the listener.

One embodiment of a non-transitory computer-readable storage medium storing executable computer program instructions for providing artist messages to listeners, comprises instructions executable to perform steps comprising receiving a plurality of artist messages from client devices of a plurality of artists, each artist message including content created using the client device of the respective artist; receiving from a client device of a listener a request for media items, the request including a seed value; providing media items selected based on the seed value to the client device of the listener; identifying a subset of the plurality of artist messages as eligible artist messages for the listener based on the media items provided to the client device of the listener; scoring the eligible artist messages based on a relevance of the message to the listener; selecting an eligible artist messages based on the scores; and providing the selected artist message to the client device of the listener.

### BRIEF DESCRIPTION OF DRAWINGS

FIG. 1 is a high-level block diagram illustrating an embodiment of an environment for presenting artist messages to users.

FIG. 2 is a high-level block diagram illustrating a detailed view of the artist application of FIG. 1, according to one embodiment.

FIG. 3 is a high-level block diagram illustrating a detailed view of modules within the content server according to one embodiment.

FIG. 4 is a high-level block diagram illustrating a detailed view of the artist message selection module of FIG. 3, according to one embodiment.

FIG. 5 is a high-level block diagram illustrating a detailed view of modules within the listener application according to one embodiment.

FIG. 6 is an example of a user interface for presenting artist messages.

FIG. 7 is a flowchart illustrating a process of presenting artist authored messages directly to users via a content system according to one embodiment.

FIG. 8 is a high-level block diagram illustrating an example computer for implementing the entities shown in FIG. 1.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

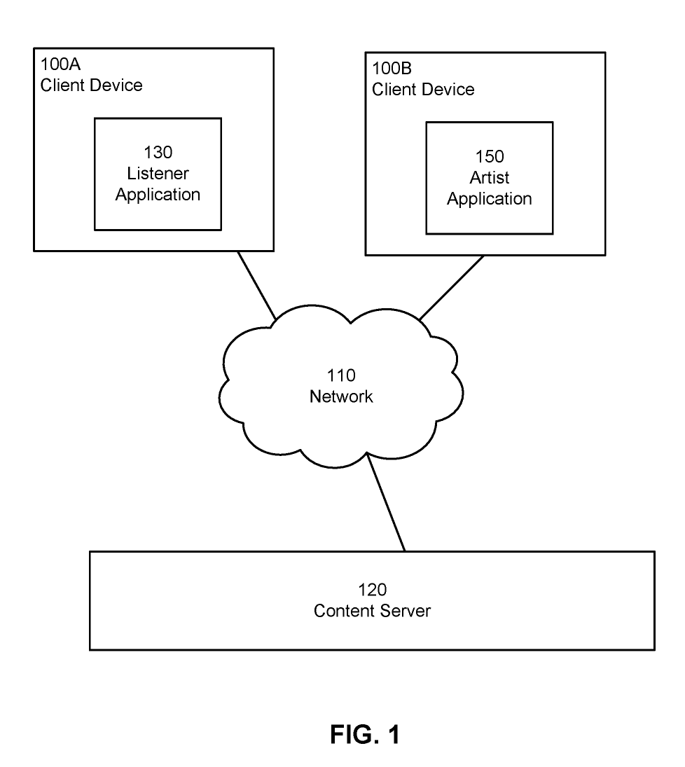

FIG. 1 is a high-level block diagram illustrating an embodiment of an environment for presenting artist messages to users. The environment includes client devices 100 connected by a network 110 to a content server 120. One client device 100A has a listener application 130 and the other client device 100B has an artist application 150. Here only two client devices 100 and one content server 120 are illustrated but there may be multiple instances of each of these entities. For example, there may be thousands or millions of client devices 100 in communication with multiple content servers 120. Additionally, although one client device 100A is shown to have the listener application 130 and one client device 100B is shown to have the artist application 150, in other embodiments each client device 100 may have one or both of these applications in any combination.

The network 110 provides a communication infrastructure between the client devices 100 and the content servers 120. The network 110 is typically the Internet, but may be any network, including but not limited to a Local Area Network (LAN), a Metropolitan Area Network (MAN), a Wide Area Network (WAN), a mobile wired or wireless network, a private network, or a virtual private network.

The client devices 100 are computing devices such as smartphones with an operating system such as ANDROID® or APPLE® IOS®, tablet computers, laptop computers, desktop computers, electronic stereos in automobiles or other vehicles, or any other type of network-enabled device on which digital content may be listened to or otherwise experienced. Typical client devices 100 include the hardware and software needed to input and output sound (e.g., speakers and microphone) and images, connect to the network 110 (e.g., via Wi-Fi and/or 4G or other wireless telecommunication standards), determine the current geographic location of the client devices (e.g., a Global Positioning System (GPS) unit), and/or detect motion of the client devices (e.g., via motion sensors such as accelerometers and gyroscopes).

The artist application 150 executes on a client device 100B and allows an artist operating the client device 100B to interact with the content server 120 and to submit artist messages to the content server 120. An artist is an entity, such as a person, group of persons, organization, or anything or anyone else that participates in the creation of the content of a media item. Examples of artists include singers, bands, a studio, an artist, a writer, and so on.

A media item is a form of media content and is characterized by a set of media features that describe the item. In one particular embodiment referred to throughout the remainder of the specification, the media item is audio content, such as a song, piece of music, or audio recording and the media features are musicological features of the item (e.g., gender of singer, tempo, style). It is appreciated, however, that in other embodiments a media item alternatively and/or additionally include other forms of digital content, such as a video, movie, slideshow, or image. Thus, subsequent references to the media item or other audio-related terminology could equally apply to (for example) viewing videos or otherwise experiencing media provided by the content server system in other embodiments.

As used here, an artist message is content (e.g., audio, video, or images) created by an artist. For example, an artist message may be an audio recording created by an artist to deliver a message to listeners of that artist's media items. In one embodiment, the artist application 150 provides the artist with an interface to create an artist message, with the interface also allowing the artist to select a call to action (e.g., to view a selected web page having) to present to the listener along with the artist message. The artist application 150 also provides the artist with an ability to select the criteria under which the artist message is presented to listeners (e.g., to present the message after a certain media item). In one embodiment, the artist application 150 allows the artist to access performance information regarding the artist messages that the artist has created. The performance information may indicate statistical information regarding how many times the artist messages have been presented to listeners, how many times listeners have interacted with call to actions, and so on. In other embodiments, the artist application 150 provides additional functionality, such as the ability to share artist messages via social network and other online systems.

In one embodiment, the artist application 150 is a browser that allows the artist of the client device 100B to submit artist messages to the content server 120 by browsing a web site of the content server 120. In another embodiment, the artist application 150 is a dedicated application specifically designed (e.g., by the organization responsible for the content server 120) to enable interactions with the content server 120 to submit artist messages to the content server 120.

The client device 100A includes a listener application 130 that allows interaction with the content server 120. For example, the listener application 130 could be a browser that allows a user of the client device 100 to obtain content by browsing a web site of the content server 120. In another embodiment, the listener application 130 is a dedicated application specifically designed (e.g., by the organization responsible for the content server 120) to enable interactions with the content server 120 and its content.

The listener application 130 presents media items, responsive to a listener selecting and/or creating a particular media channel. A media channel is a playlist of media items that are grouped together, where the media items share one or more common media features. The listener application 130 requests content associated with the requested media channel from the content server 120. The listener application 130 receives media items from the content server 120 (e.g., the media item is streamed) associated with the requested media channel and presents the media items to the user. These media items may include one or more artist messages as selected by the content server 120 to be presented to the listener.

The listener application 130 collects feedback from the client device 100 presenting the media items. The feedback may include express feedback and/or implicit feedback. Express feedback is feedback provided by the listener that directly expresses the listener's preferences (i.e., like or dislike) for a media item. For example, express feedback may be a listener's rating of a media item, a listener selecting a thumbs up icon or thumbs down icon to respectively indicate approval or disapproval, or some other action by the listener that directly expresses his/her preference for a media item. Implicit feedback is feedback that implicitly describes a listener's preferences for a media item. Implicit feedback may be positive or negative. Examples of positive implicit feedback include allowing a media item to play through until completion, sharing a media channel with another user of the content server 120, purchasing a media item that is being presented, and adding a media channel based on the media item. Examples of negative implicit feedback include the listener skipping a media item after partial playback of the media item, pausing presentation of a media item, and changing a media channel during playing of a media item.

In one embodiment, the artist application 150 and the listener application 130 are modules of a single application. Depending upon the credentials of the user that uses the combined application, the application presents a module with the artist application 150 or a module with the listener application 130 to the user. For example, if the user is configured to be an artist, the combined application may present the user with the artist application 150.

The content server 120 generates media channels that are specific to a listener of the client device 100. The content server 120 may initially generate a media channel based on a seed value input from the listener (e.g., name of a song or band) using a list of global list of media items associated with the input. The content server 120 receives requests for content from the client devices 100. The content server 120 identifies a media channel associated with the request for content, and streams media items associated with the media channel to the requesting client device 100. In one embodiment, the content server 120 also collects feedback (i.e., express feedback and/or implicit feedback) from the client device 100 associated with the listener. Over time, the same media item may be provided to the client device 100 and presented to the user many times. The content server 120 collects feedback for these multiple presentations of the media item.

In one embodiment, the content server 120 selects artist messages to present to a listener when the listener is consuming a media channel. The content server 120 determines from a database of artist messages those artist messages for which the listener is eligible. The content server 120 may determine the eligibility based upon whether the listener is currently being presented with a media channel having a seed value associated with the artist of the artist message, and so on. Once a set of eligible artist messages is selected, the content server 120 filters these messages based on a variety of factors. For example, an artist message may be filtered out if it has been previously played in a particular time window, or an artist message may be filtered out if the user is not in a correct geographic location. After filtering the set of eligible artist messages, the content server 120 scores the remaining artist messages based on the listener's prior feedback or other actions and selects one or more artist messages with the highest score to present to the listener for consumption.

By allowing an artist to create and submit artist messages directly to the content server 120 for consumption by listeners, the content server 120 allows artists to directly interact with listeners. The artist can thus more easily reach listeners without having to negotiate with other parties, and is able to target those listeners that are likely to be interested in the artist messages.

Furthermore, the content server 120 can present artist messages to listeners with little or no delay after the artist messages are submitted by artists. The content server 120 thus allows artists to quickly and in real-time (or near real time) broadcast messages to listeners. For example, an artist may broadcast a message to one or more eligible listeners indicating that the artist is hosting an impromptu event, or that the artist is holding a last minute giveaway for tickets.

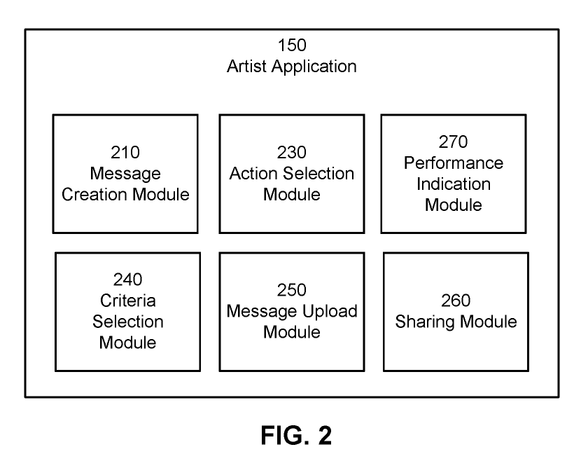

Additional details regarding the listener application 130, artist application 150, and content server 120 are now described in more detail with respect to FIGS. 2-8 below.

FIG. 2 is a high-level block diagram illustrating a detailed view of the artist application 150 of FIG. 1, according to one embodiment. The artist application 150 includes a message creation module 210, an action selection module 230, a criteria selection module 240, a message upload module 250, a sharing module 260, and a performance indication module 270. Some embodiments of the artist application 150 have different modules than those described here. Similarly, the functions can be distributed among the modules in a different manner than is described here.

The artist application 150 includes a message creation module 210 that allows the artist to create artist messages. The message creation module 210 interfaces with the artist through the client device 100 to allow the artist to create one or more artist messages. In one embodiment, an artist message comprises an audio recording. The message creation module 210 presents an interface to the artist to allow the artist to create this audio recording using the client device 100. For example, the artist may create the audio recording using a microphone of a smartphone that is running the artist application 150. The content of the audio recording for the artist message may be determined by the artist, but the message creation module 210 may limit the audio recording to a certain length (e.g., 15 seconds).

The message creation module 210 may also present an interface to the artist to allow the artist to preview the artist message after it has been created, and allow the artist to re-record the message or modify it (e.g., cut it, reduce noise, etc.).

In one embodiment, the message creation module 210 presents the artist with the ability to add additional content to the artist message. The additional content may be an image, video, or other content. In one embodiment, the message creation module 210 may prompt the artist to submit an image associated with the audio recording as the image may be presented to a listener when the listener is presented with the audio recording of the artist message. For example, if the audio recording made by the artist pertains to an upcoming concert, the artist may also wish to submit as an image the poster for the concert.

The message creation module 210 may present the artist with an opportunity to submit more than one image for the artist message. Different images may be used depending upon the state of the listener application 130 on the client device 100 of the listener (e.g., in foreground, in background, switched to), and thus the message creation module 210 may prompt the artist to determine whether the artist wishes to submit a different image for each of these states. If the message creation module 210 does not receive a submission of an image from the artist, the message creation module 210 may select a default image to associate with the artist message. This default image may be a default image associated with the artist that is stored by the content server 120 (e.g., album art).

In one embodiment, the message creation module 210 also presents the artist with the ability to manage existing artist messages, such as to change the criteria, call to action, or the content in existing artist messages, as well as to delete artist messages.

The artist application 150 includes an action selection module 230 that allows the artist to associate a call to action with the artist message. As noted, a call to action defines an action that a listener can perform after or during presentation of the artist message. These actions may include, but are not limited to 1) visiting a website, 2) making a purchase, 3) playing a media item, 4) consuming an extended artist message that is presented to the listener, and so on.

In one embodiment, the action selection module 230 presents a limited number of actions from which the artist may select (e.g., via a drop down menu). In one embodiment, the call to action is represented by a link (such as a hyperlink/web link). If the listener decides to perform the call to action represented in the link, the listener may interact with the link to initiate the call to action (e.g., the action is to visit a web page and the link is a link to the web page). In such a case, the action selection module 230 may allow the artist to directly provide a link (e.g., a link represented by text characters) that is to be the call to action. The action selection module 230 may automatically analyze the link to understand what type of call to action is represented by that link. For example, if the link includes an identifier for an e-commerce website, the action selection module 230 may assume that the link represents a call to action to purchase something. By determining the call to action type of the link, the action selection module 230 may associate the type of call to action with the artist message (e.g., as metadata). Note that in some embodiments, the function of determining the type of call to action represented by the link may be performed by the content server 120 instead.

The artist application 150 includes a criteria selection module 240 that allows the artist to select the criteria under which the artist message is presented to a listener. When some or all of the criteria (i.e., requirements) for an artist message are satisfied for a listener being presented with media items, then the artist message may be presented to the listener. If the criteria are not met, then the artist message is not presented to the listener.

In one embodiment, the criteria selection module 240 allows the artist to select a media channel as a criterion such that the artist message is presented during the presentation of the media channel to the user. If an artist message has a particular media channel as a criteria, and the listener has selected that particular media channel (either due to selecting the media channel via a seed value input or selecting the media channel from a list of previously presented media channels), the artist message may be presented to the listener at some point in time when the listener is consuming the media items of the media channel. In one embodiment, the criteria selection module 240 allows the artist to have the artist message play at a certain point in time during the presentation of the media channel to the user, such as right before the first media item in the media channel is presented to the user, after a certain period of time, or after the listener decides to select a new media channel before the new media channel is presented to the listener (i.e., right before the presentation of the current media channel ends). As an example, the criteria selection module 240 may allow the artist to select as a criterion a media channel that is created by a seed input matching the name of the artist.

In one embodiment, the criteria selection module 240 allows the artist to select a media item as a criterion for presentation of the artist message such that the artist message may be presented to a listener before or after the presentation of that particular media item. The criteria selection module 240 may allow the artist to select whether the artist message should be presented before or after the media item. For example, the artist could set as one criterion that an artist message is to be presented to a listener before the presentation of a particular new song (such that the artist message might be to introduce the new song).

In one embodiment, the criteria selection module 240 allows the artist to select an artist (e.g., a musical artist) as a criterion for presentation of the artist message such that the artist message may be played before or after the presentation of a media item (e.g., a song) by the artist (i.e., authored by the artist), or may be played during the presentation of a media channel including one or more media items by the artist, or may be played in a media channel that is created using a seed input corresponding to the artist. The criteria selection module 240 may allow the artist to select whether the artist message should be presented before or after the media item, or when the artist message should be presented during the presentation of the media channel to the listener. For example, the artist could set as one criterion that an artist message is to be presented during a media channel created with a seed value corresponding to a band to which the content artist belongs.

In one embodiment, the criteria selection module 240 allows the artist to select media item metadata as a criterion for presentation of the artist message such that the artist message is played before or after the presentation of a media item with that metadata. Examples of metadata for media items may include the genre for that media item, the parental rating for that media item, the length of that media item, the publication data for that media item, and so on. As noted, the criteria selection module 240 may allow the artist to select when to present the artist message when the media items are being presented to the listener. For example, the artist could set as one criterion that an artist message is to be presented during a media channel associated with “Classic Rock.”

Note that in one embodiment, for the criteria described above, the criteria selection module 240 allows the artist to set the criteria for only elements related to or owned by the artist. For example, the criteria selection module 240 may allow the artist to select as a criterion only those media items that are authored by the artist, or may allow the artist to select only the artist as a criterion and not any other unrelated artists, or may allow the artist to only select as a criterion metadata (e.g., genre) that is associated with any of the media items by the artist (e.g., genres to which the artist's media items belong).

In one embodiment, the criteria selection module 240 allows the artist to select certain listener feedback as a criterion for presentation of the artist message such that the artist message may be presented to a listener only when the listener has feedback that is similar to the feedback criteria set for the artist message. For example, the artist could set as one criterion that an artist message is to be presented to listeners whom have expressed explicit positive feedback regarding media items by the artist.

In one embodiment, the criteria selection module 240 allows the artist to select listener demographics as a criterion for presentation of the artist message such that the artist message may be presented to a listener only when the specified demographics for the listener are satisfied. Demographics may include information such as age, gender, income, geographic region, ethnicity, etc., that may be collected by the content server 120 for listeners based on information that the listener may provide to the content server 120. For example, the artist could set as one criterion that an artist message is to be presented to listeners who are male.

In one embodiment, the criteria selection module 240 allows the artist to select a location as a criterion for presentation of the artist message such that the artist message is presented only when the listener is at a particular location or within a particular geographical region specified by the location. For example, the artist could set as one criterion that an artist message is to be presented to listeners only within the vicinity of a concert that is to be hosted by the artist.

In one embodiment, the criteria selection module 240 allows the artist to select a time or time period as a criterion for presentation of the artist message such that the artist message is presented only when the current time satisfies the time criteria. For example, the artist could set as one criterion that an artist message is to be presented to listeners only within a particular time and/or date range.

In one embodiment, the criteria selection module 240 allows the artist to select connection type as a criterion for presentation of the artist message such that the artist message may be presented only when the client device 100 of the listener is using a particular connection type to connect the client device 100 to the client server 120 (e.g., cellular or Wi-Fi).

In one embodiment, the criteria selection module 240 allows the artist to select type of a listener's current client device 100 as a criterion for presentation of the artist message such that the artist message may be presented only when the client device 100 of the listener is of a particular type (e.g., mobile device, desktop computer, car infotainment system).

In one embodiment, the criteria selection module 240 allows the artist to select an exclusionary criteria, such that the artist message is only presented when the criteria is not met. Any one of the criteria described above may be set to be excluded. For example, the artist can set as one exclusionary criterion that an artist message is to be presented to a listener only outside of a particular time period.

The artist application 150 includes a message upload module 250 that uploads the artist message, which includes the call to action and criteria, to the content server 120. In one embodiment, immediately or a short period of time (e.g., 5 seconds) after the creation of the artist message is completed, the message upload module 250 uploads the artist message to the content server 120 for immediate or near-immediate (e.g., 5 minutes) presentation to listeners (based on the criteria and other factors).

The artist application 150 includes a sharing module 260 that allows the artist to share a created artist message to one or more social media systems or other online systems. After an artist message is uploaded to the content server 120, the sharing module 260 presents the artist with an option to share the artist message. If the artist indicates a desire to share the artist message, the sharing module 260 communicates with the content server 120 to request a sharing link (e.g., a shortened uniform resource locator (URL)) that the artist may use to post to online systems, such as social media systems. Alternatively, the sharing module 260 shares the artist message directly to one or more social media systems for which it has received authorization from the artist. In some cases, due to licensing issues, some artist messages may not be shared directly (e.g., artist messages that have a criterion to be presented directly before or after a music item might not be sharable due to radio licensing issues). In such a case, the sharing module 260 may present a message to the artist indicating that sharing is not available for this artist message. The sharing module 260 may also be able to present to the artist the option to share previously created artist messages as well.

The artist application 150 includes a performance indication module 270 that allows the artist to view information regarding artist messages that have been uploaded to the content server 120 for presentation to listeners. The performance indication module 270 may retrieve this information from the content server 120 to present to the artist.

In one embodiment, the performance indication module 270 presents to the artist with the statistics regarding the performance of the artist messages that the artist has selected for presentation to listeners. The performance indication module 270 may indicate to the artist the number of listeners that have listened to artist messages made by the artist. For each artist message, the performance indication module 270 may show the artist how that artist message has performed, including how many listeners interacted with the call to action (e.g., clicked on the link), whether listeners provided feedback (positive or negative) regarding the artist message, how many times the artist message was presented, how many other listeners had been presented with media items made by the artist but who had not been presented with the artist message. In other embodiments, the performance indication module 270 presents other useful information about artist messages to the artist.

The performance statistics presented by the performance indication module 270 allows the artist to determine the effectiveness of the artist message. Based on the information provided by the performance indication module 270, the artist may wish to modify the artist message, create a new one, or perform some other responsive action.

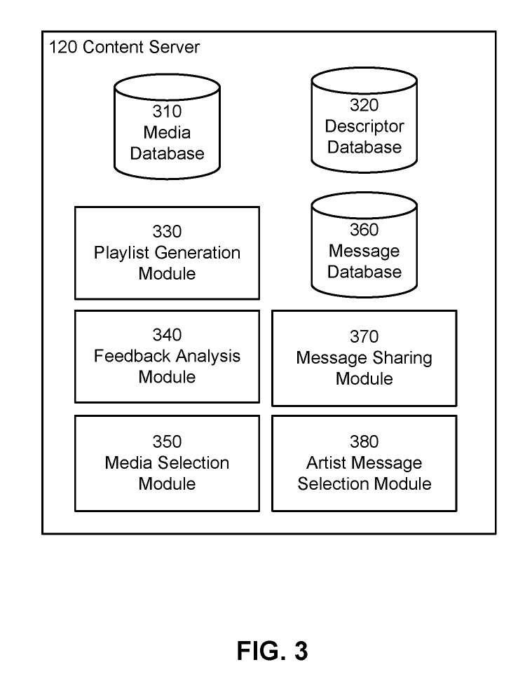

Turning now to a discussion of the structure of the content server 120, FIG. 3 is a high-level block diagram illustrating a detailed view of modules within the content server 120 according to one embodiment. Some embodiments of the content server 120 have different modules than those described here. Similarly, the functions can be distributed among the modules in a different manner than is described here. The content server 120 is comprised of modules including a media database 310, a descriptor database 320, a playlist generation module 330, a feedback analysis module 340, a media selection module 350, a message database 360, a message sharing module 370, and an artist message selection module 380.

The media database 310 stores information relating to media items, such as the media items and associated metadata (e.g., artist, name of track, etc.), playlists, and mappings of media items to media features. As mentioned above, the media features (also referred to as musicological features) describe musicological characteristics of media items. For example, if the media item is a song, the media features of the song may indicate the underlying musicological characteristics of the song such as e.g., the gender of the singer, the type of background vocals, the tempo, the quality of the tones (e.g., pure or distorted), whether the melody dominates the composition, and an amount of gospel influence. A given media item may have many media features, such as 100-500 media features. In one embodiment, the mapping of media items to media features is established using the MUSIC GENOME PROJECT database created by PANDORA MEDIA, INC. of Oakland, Calif.

The descriptor database 320 stores information describing listener preferences for media items and media features. In one embodiment, this information is represented as preference descriptors. The descriptors may associate the listener's preference information with the media item features that characterize the media item. Since a media item may be presented to a listener multiple times, there may be multiple preference descriptors for a user for a media item (e.g., one for every time a media item characterized by the media feature is presented by the client device 100 to the listener).

The playlist generation module 330 generates media item playlists. The playlist generation module 330 receives a seed value from a listener. A seed value is an input from the listener that describes what type of media channel he/she would like formed. A seed value may be, e.g., a name of a song, a name of a band, a name of an artist, a name of genre of music, etc., and in some embodiments, the seed value may be characterized by a plurality of media features. The playlist generation module 330 may extract media features from the seed value using, e.g., the mappings of media items to corresponding media features in the media database 310. The playlist generation module 330 uses the media features and the mappings of media items to media features to dynamically generate a media item playlist of media items having media features associated with the seed value. For example, given a seed value of a band, the playlist generation module 330 identifies media features that characterize the band. The playlist generation module 330 then identifies songs with the same or similar media features. The playlist generation module 330 then uses the identified songs to generate a media playlist which is associated with the band.

The feedback analysis module 340 analyzes the collected feedback from listeners and to determine listeners' preferences for media items (i.e., likes and dislikes) and the magnitudes of these preferences (i.e., the amount of the likes and dislikes). In some embodiments, the feedback analysis module 340 analyzes for a media item a series of collected feedback for that media item to determine a listener's preference for the media item. In one embodiment, the feedback analysis module 340 represents the preferences and magnitudes as a preference score. Note, for each user, each media item in each media playlist for that user has its own preference score. To compute the score, the feedback analysis module 340 assigns weights to the various types of feedback that may be present in the listener preference information. Very strong signals of preference (e.g., an express thumbs up or thumbs down) are afforded relatively higher weights, while weaker signals of preference such as the various types of implicit feedback are afforded relatively lower weights. The weighted feedback is then combined to produce the preference score. As a given media item may be presented to a given listener multiple times, the feedback analysis module 340 may produce multiple preference scores for a media item and listener.

The media selection module 350 selects media items using a playlist that is associated with a listener for presentation to the listener. The playlist may be one that is generated by the playlist generation module 330. In one embodiment, the media selection module 350 selects the media items from the media database 310 based on the preferences for the listener as determined by the feedback analysis module 340, and provides the selected media item to the client device 100. In some embodiments, the media selection module 350 may remove from consideration media items in that have preference scores below a threshold value. Accordingly, the media selection module 350, in effect, customizes the media playlist to the listener's preferences given the feedback of the user.

The message database 360 stores information related to artist messages, including the artist messages uploaded by the artist application 150, and the criteria for each artist message, the content of the artist message, the call to action indicated for each artist message, and so on. The message database also stores performance statistics collected by the content server 120 and related to each artist message, as described above for the performance indication module 270. The message database 360 may also store sharing links that are associated with artist messages.

In one embodiment, the message sharing module 370 receives requests from the sharing module 260 of the artist application 150 to generate sharing links for artist messages. The message sharing module 360 generates the sharing link and stores it with the associated artist message in the message database 360. In one embodiment, the message sharing module 360 generates a shortened link, such as a shortened URL. The shortened URL may be in the form of a shortened domain name (that is owned by the same owner as the content server 120) appended with a randomly generated identifier (e.g., an alphanumeric key) that is generated by the message sharing module 370 and which uniquely identifies the artist message to be shared. In one embodiment, when another user interacts with this shortened link, this user is redirected to the listener application 130 and the information in the shortened link is passed to the listener application 130, causing the listener application 130 to present the artist message to the user and play the associated media channel.

The artist message selection module 380 selects artist messages for presentation to a listener based on listener eligibility and artist message criteria. As noted, artist message criteria may be criteria that an artist indicates to associate with an artist message such that the artist message is presented to a listener only when the criteria are met. When a listener is being presented with a media item, or prior to the listener application 130 presenting the listener with media items from a media channel, the artist message selection module 380 determines whether the listener should be presented with an artist message, and if so, which artist message to present to the listener. The artist message selection module 380 initially identifies all artist messages eligible for presenting to the listener. This eligibility may depend upon the current media items that are to be presented to the listener or the listener's preferences. The artist message selection module 380 subsequently determines a subset of these eligible artist messages to present to the listener by removing inapplicable artist messages based on one or more filters and the criteria for the artist message as specified by the artist. The remaining artist messages are scored, and one or more artist messages with the highest score are presented to the listener.

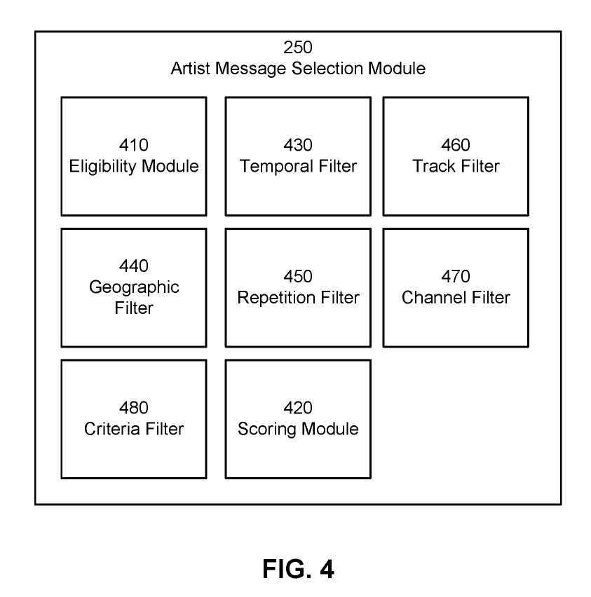

FIG. 4 is a high-level block diagram illustrating a detailed view of the artist message selection module 380 of FIG. 3, according to one embodiment. The artist application 150 includes an eligibility module 410, a scoring module 420, and one or more filters, including a temporal filter 430, a geographic filter 440, a repetition filter 450, a track filter 460, a channel filter 470, and a criteria filter 480. Some embodiments of the artist message selection module 380 have different modules than those described here. Similarly, the functions can be distributed among the modules in a different manner than is described here.

The eligibility module 410 identifies the eligible artist messages for a listener based on the media items provided to the listener. The eligibility module 410 may identify eligible artist messages based on the seed value selected by the listener and used to create the media channel that includes the media items, based on the media item indicated in a seed value selected by the listener, and/or based on feedback from the listener regarding the media items.

In one embodiment, the eligibility module 410 identifies the seed value that is used or was used to generate the media channel for the media items that are to be presented (as selected by the content server 120). If the artist is identified by the seed value, or if a media item by the artist is identified by the seed value, the eligibility module 410 identifies as eligible artist messages those artist messages created by that artist.

In one embodiment, the eligibility module 410 also identifies the artist messages of an artist as eligible artist messages when one of the media items that is to be presented in the current media channel is by the artist, although the seed value for the current media channel neither identifies the artist nor a media item by the artist, as long as the listener has previously selected a media channel with a seed value identifying the artist or identifying a media item by the artist. For example, assume a listener has previously selected a media channel with a seed value of an artist named “Spinal Tap.” Subsequently, if the listener selects a media channel with a seed value of “70's Rock,” and a media item by “Spinal Tap” is selected for presentation by the content server 120, the eligibility module 410 may determine that artist messages created by “Spinal Tap” are eligible for presentation to the listener.

In one embodiment, the eligibility module 410 determines that the artist messages of an artist are eligible depending upon preferences for the listener. In particular, if the listener has indicated a lifetime number of positive feedback events (e.g., thumbs up) for the artist and/or media items by the artist beyond a certain threshold, the eligibility module 410 may determine that the artist messages created by the artist are eligible artist messages. This may occur even if the listener has not previously selected a media channel with a seed value identifying the artist or media items by the artist. As used here, “lifetime” refers to the point at which the listener first created an account with the content server 120 (or first used the content system) to a present time.

After the eligibility module 410 identifies the eligible artist messages, one or more filters may be applied to the set of eligible artist messages to remove certain messages from consideration. The filters may be based upon the criteria set for each artist message, based on the seed value of the media channel being presented to the listener, based on global constraints applicable to all artist messages, or based on other factors. The purpose of the filters is to remove messages that are not relevant to a particular listener. For example, a filter may remove eligible artist messages from consideration because the criteria for the artist messages are not met. Other exemplary filters are described below; however the filters that may be implemented should not be construed as being limited to those described.

The temporal filter 430 removes eligible artist messages from consideration due to time constraints. In one embodiment, the temporal filter 430 removes eligible artist messages when the time of day criteria as set by the artist for those artist messages are not met. For example, if an artist message is to be broadcast from 9 AM to 5 PM in the listener's time zone, then that message is removed from consideration if the current time is not between 9 AM to 5 PM (i.e., the current time is between 5 PM to 9 AM). In one embodiment, the temporal filter 430 removes eligible artist messages if another artist message from the same artist of the same artist message has been presented to the listener previously within a set period of time (e.g., 24 hours).

The repetition filter 450 removes eligible artist messages from consideration due to repetition. In one embodiment, the repetition filter 450 removes particular eligible artist messages if the particular artist messages have been presented to the user in the past, or if they have been presented a certain number of times (e.g., two). In another embodiment, the repetition filter 450 removes any eligible artist message when that artist message has been presented a lifetime maximum number of times (even though each message was presented not more than once per the set period of time as described above).

The geographic filter 440 removes eligible artist messages from consideration due to geographic constraints. In one embodiment, the geographic filter 440 removes messages where the geographic constraints as set by the artist for those messages do not match the current geographic information for the listener. For example, if the listener is not in a geographic region specified by the criteria in the artist message, then the geographic filter 440 removes that artist message from consideration. In one embodiment, the geographic location is determined by a postal code provided by the listener when the listener registered for the content system. In one embodiment, the location is indicated by the client device 100 of the listener (via a location sensor).

The track filter 460 removes eligible artist messages from consideration due to constraints related to media items that are to be presented to the listener. In one embodiment, the track filter 460 removes eligible artist messages that have as a criterion set by the artist indicating that the artist message is to be presented before or after (i.e., adjacent to) certain media items, and an upcoming media item(s) to be presented is not one of these media items. For example, if an artist has created an artist message that has as a criterion which indicates that artist message is to be presented after a media item, and the upcoming media item to be presented to the listener is not the media item specified in the criterion, then the track filter 460 removes that artist message from consideration.

The channel filter 470 removes eligible artist messages from consideration due to constraints regarding the selection of a media channel. In general, the channel filter 470 may remove eligible artist messages when a new media channel is selected or based on the current media channel. In one embodiment, the channel filter 470 removes eligible messages if the next media item to be presented to the listener results from a change of media channels or an initial selection of a media channel, and the artist message includes certain call to actions that listeners may find undesirable when they are presented with them during the presentation of the initial media item of a media channel. These call to actions may include a link to purchase a media item, to purchase a product, to purchase tickets, etc. Additionally, the channel filter 470 may remove any artist messages that may resemble an advertisement from consideration for presentation at the beginning of a change of media channels. In one embodiment, the channel filter 470 removes from consideration artist messages that have as a criterion that the artist message only be presented for a particular media channel, and the current media channel that is being presented does not match this media channel set in the criteria.

In one embodiment, the artist message selection module 250 also includes a criteria filter 480 to remove eligible artist messages from consideration when any other criteria that the artist may have set for the artist message is not met. In one embodiment, the artist message may include demographic criteria, listener feedback criteria, device and connection criteria, exclusionary criteria, and/or any other criteria that may be allowed by the content system. In such a case, the criteria filter 480 further removes from consideration those eligible artist messages for which the criteria are not met.

The scoring module 420 scores the remaining eligible artist messages that pass through the filters. The score may be based on a potential relevance of the artist message to a listener. In one embodiment, the scoring module 420 scores each remaining eligible artist message based on the interactions of the listener (to whom the eligible artist messages are to be presented) with the content system. These interactions may include the feedback a listener has provided for media items and artist message by the artist. The scoring module 420 may determine a score for each listener and artist indicating the value of that listener to the content system with regard to the particular artist. Each element of positive feedback may be weighted positively (e.g., increase) on the score for that listener and artist, with each element of negative feedback weighted negatively (e.g., decrease the score). Each type of feedback may have a different weight, which may depend upon the amount of interaction needed for that feedback. For example, an implicit feedback event may be weighted more than an implicit feedback event.

In one embodiment, the scoring module 420 scores each remaining eligible artist message based on how many constraints that are associated with the artist message are satisfied. If a higher number of constraints are satisfied for an artist message, the scoring module 420 may increase the score associated with that artist message proportionally. In one embodiment, the constraints are the constraints used by the filters to filter out artist messages, and no filters are applied to the eligible artist messages before the scoring module 420 scores the messages.

Once the remaining set of eligible artist messages have been scored by the scoring module 420, the scoring module 420 selects an artist message based on the scores. In one embodiment, the scoring module 420 selects the artist message with the highest score for presentation to the listener. This selected artist message may be set to be presented to the listener before or after the next media item to be presented depending on the criteria set by the artist for that media item. In one embodiment, if more than one eligible artist message has the same high score (or if they have high scores within a particular range), then the scoring module 420 may randomly select one of the messages for presentation to the listener.

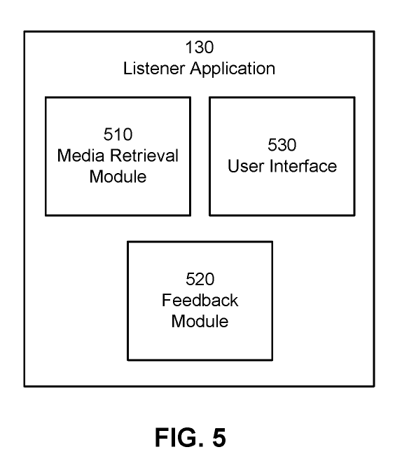

Turning now to a discussion of the structure of the listener application 130, FIG. 5 is a high-level block diagram illustrating a detailed view of modules within the listener application 130 according to one embodiment. Some embodiments of the listener application 130 have different modules than those described here. Similarly, the functions can be distributed among the modules in a different manner than is described here. The listener application 130 is comprised of modules including a media retrieval module 510, a feedback module 520, and a user interface 530.

The media retrieval module 510 retrieves or receives media items and artist messages from the content server 120 for presentation to the listener of the client device 100 executing the listener application 130.

The feedback module 420 collects feedback from the listener and sends this feedback to the content server 120. In one embodiment, the listener application 130 allows the listener to provide explicit feedback with regards to presented artist messages (e.g., thumbs up, survey responses).

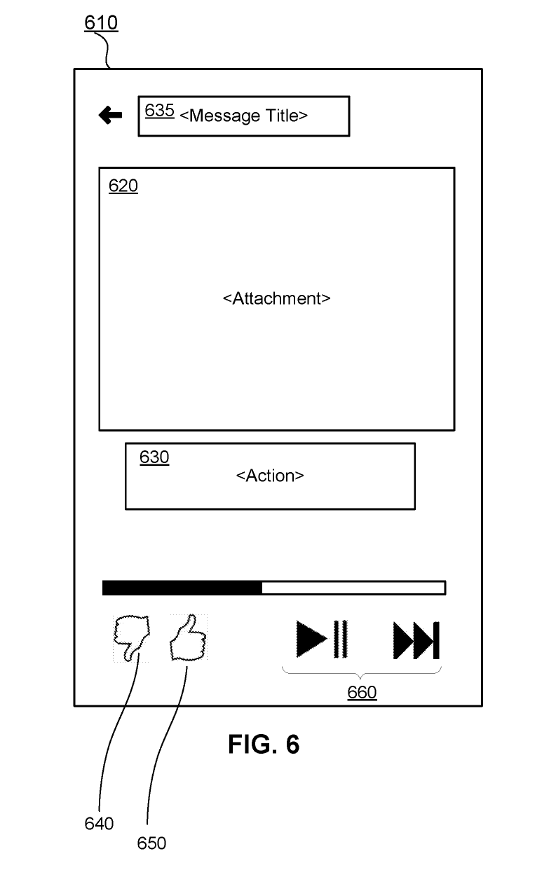

The user interface 530 presents artist messages and media items to the listener and provides options for the listener to provide feedback for a currently playing media item. An example of such a user interface 530 for presenting artist messages is described in FIG. 6. As shown in FIG. 6, the user interface 530 may include a message title 635 indicating a title of the artist message which may be set by the artist or default to the name of the artist, media item, media channel, or a generic title (e.g., “Artist Message”). The user interface 530 may also include an attachment 620 that presents the attachment of the artist message to the listener. This attachment 620 may be an additional media item such as an image or video that the artist included in the artist message, or may be a default image provided by the content server 120 for the artist. The user interface 530 may also include an action indicator 630, which allows the listener to interface with the call to action of the artist message. The user interface 530 includes feedback elements 640 and 650, which may in some embodiments allow the listener to provide feedback regarding an artist message that is presented. The user interface 530 may also include controls 660 that allow a user to skip, pause, or play the artist message.

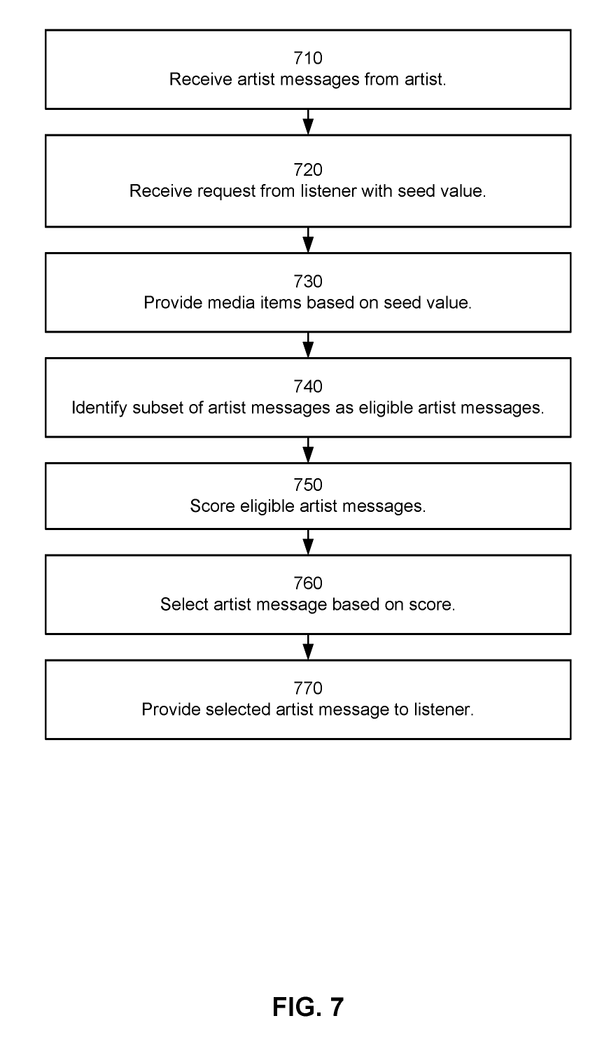

FIG. 7 is a flowchart illustrating a process of presenting artist authored messages directly to users via a content system according to one embodiment. In one embodiment, the process of FIG. 7 is performed by the content server 120. Other entities may perform some or all of the steps of the process in other embodiments. Likewise, embodiments may include different and/or additional steps, or perform the steps in different orders.

The content server 120 receives 710 artist messages from the client device 100B. Each artist message includes content created by the artist using the client device 100B. In one embodiment, an artist message includes an audio recording, artist message criteria, and a call to action.

The content server 120 receives 720 from a client device 100A of a listener a request for media items. The request includes a seed value indicating a media channel that the listener desires to receive.

The content server 120 provides 730 media items selected based on the seed value to the client device 100A of the listener.

The content server 120 identifies 740 a subset of the artist messages as eligible artist messages for the listener based on the media items that are provided to the listener, the seed value of the request from the client device of the listener, a past seed value provided by the listener, listener feedback, and so on. In one embodiment, if the seed value indicates the artist or a media item by the artist, the content server 120 selects as eligible artist messages all artist messages by that artist. In one embodiment, if a listener has previously selected a seed value indicating the artist or a media item by the artist, then the content server 120 selects as eligible artist messages those artist messages by that artist if a media item by that artist is to be provided to the user, even if the current seed value does not indicate the artist or a media item by the artist. In one embodiment, the content server 120 selects as eligible artist messages those artist messages by an artist if the listener has previously indicated a number of positive feedback events for that artist that are beyond a threshold value.

In one embodiment, the content server 120 filters the eligible artist messages to remove certain artist messages. In one case, the content server 120 removes artist messages due to a criterion as selected by the artist of the artist message not being met. For example, the criterion may indicate that the artist message be presented only adjacent to a particular media item. In one case, the content server removes artist messages due to a constraint that applies to all artist messages. For example, such a constraint may indicate that an artist message may not be presented more than once every 24 hours. In another case, the content server 120 removes artist messages due to the geographic location of the listener.

The content server 120 scores 750 the eligible artist messages based on the relevance of the message to the listener. In one embodiment, the relevance is based on feedback provided by the listener. The feedback may be the feedback of the listener with respect to media items of the artist.

The content server 120 selects 760 the eligible artist messages based on the score (e.g., the highest score). The content server 120 provides 770 this message to the listener.

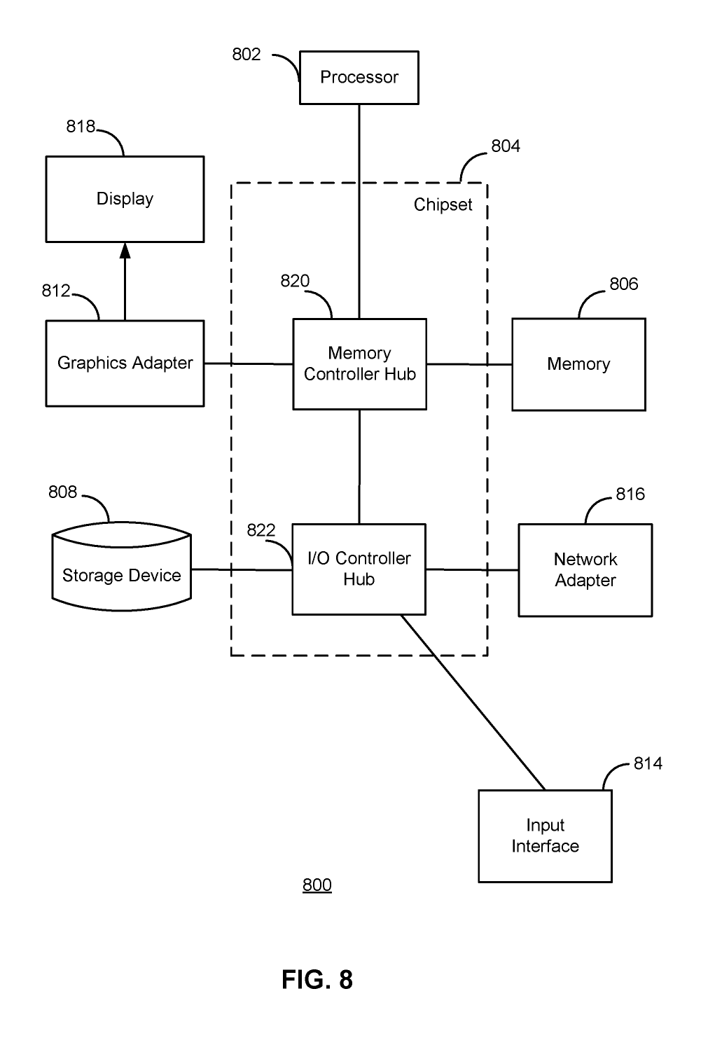

Turning now to a discussion of the implementation of client device 100 and/or the content server 120, FIG. 8 is a high-level block diagram illustrating an example computer 800 for implementing one or more of the entities shown in FIG. 1. The computer 800 includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, an input device 814, and network adapter 816 are coupled to the I/O controller hub 822. Other embodiments of the computer 800 have different architectures.

The storage device 808 is a non-transitory computer-readable storage medium such as a hard drive, compact disk read-only memory (CD-ROM), DVD, or a solid-state memory device. The memory 806 holds instructions and data used by the processor 802. The input interface 814 is a touch-screen interface, a mouse, track ball, or other type of pointing device, a keyboard, or some combination thereof, and is used to input data into the computer 800. In some embodiments, the computer 800 may be configured to receive input (e.g., commands) from the input interface 814 via gestures from the user. The graphics adapter 812 displays images and other information on the display 818. The network adapter 816 couples the computer 800 to one or more computer networks.

The computer 800 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 808, loaded into the memory 806, and executed by the processor 802.

The types of computers 800 used by the entities of FIG. 1 can vary depending upon the embodiment and the processing power required by the entity. For example, the content server 120 can run in a single computer 800 or multiple computers 800 communicating with each other through a network such as in a server farm. The computers 800 can lack some of the components described above, such as graphics adapters 812, and displays 818.

### Other Considerations

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for selecting content based on correlations between preferred media features and specific configurations of environmental information. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

1. A method for providing artist messages to listeners, comprising:
receiving a plurality of artist messages from client devices of a plurality of artists, each artist message including content created using the client device of the respective artist;
receiving from a client device of a listener a request for media items, the request including a seed value;
providing media items selected based on the seed value to the client device of the listener;
identifying a subset of the plurality of artist messages as eligible artist messages for the listener based on the media items provided to the client device of the listener;
scoring the eligible artist messages based on a relevance of the message to the listener;
selecting an eligible artist messages based on the scores; and
providing the selected artist message to the client device of the listener.

2. The method of claim 1, wherein the identifying a subset of the plurality of artist messages as eligible artist messages for the listener further comprises:
determining that the seed value indicates one of an artist or a media item by that artist; and
selecting as eligible artist messages those of the subset of the plurality of artist messages that are by that artist.

3. The method of claim 1, wherein the scoring the plurality of eligible artist messages further comprises:
identifying feedback from the listener that is associated with an artist having an eligible artist message; and
scoring the eligible artist message based on the feedback.

4. The method of claim 1, further comprising:
filtering the eligible artist messages to remove artist messages, the filtering based on one or more criteria set for each eligible artist message by a corresponding artist.

5. The method of claim 4, wherein one of the criteria indicates that an artist message is to be presented to a user only when adjacent to a particular media item.

6. The method of claim 1, further comprising:
filtering the eligible artist messages to remove artist messages, the filtering based on a geographic location of the listener.

7. The method of claim 1, further comprising:
filtering the eligible artist messages to remove artist messages, the filtering based on a determination of whether the artist message has been previously provided to the listener within a period of time.

8. The method of claim 1, further comprising:
filtering the eligible artist messages to remove artist messages, the filtering based on a whether a particular media item is to be presented to the listener.

9. The method of claim 1, wherein each artist message comprises:
a call to action comprising a link to be presented to the listener concurrently with the audio recording, the link adapted to perform an action when activated by the listener.

10. A non-transitory computer-readable storage medium storing executable computer program instructions for providing artist messages to listeners, the instructions executable to perform steps comprising:
receiving a plurality of artist messages from client devices of a plurality of artists, each artist message including content created using the client device of the respective artist;
receiving from a client device of a listener a request for media items, the request including a seed value;
providing media items selected based on the seed value to the client device of the listener;
identifying a subset of the plurality of artist messages as eligible artist messages for the listener based on the media items provided to the client device of the listener;
scoring the eligible artist messages based on a relevance of the message to the listener;
selecting an eligible artist messages based on the scores; and
providing the selected artist message to the client device of the listener.

11. The computer-readable medium of claim 10, wherein the identifying a subset of the plurality of artist messages as eligible artist messages for the listener further comprises:
determining that the seed value indicates one of an artist or a media item by that artist; and
selecting as eligible artist messages those of the subset of the plurality of artist messages that are by that artist.

12. The computer-readable medium of claim 10, wherein the scoring the plurality of eligible artist messages further comprises:
identifying feedback from the listener that is associated with an artist having an eligible artist message; and
scoring the eligible artist message based on the feedback.

13. The computer-readable medium of claim 10, the steps further comprising:
filtering the eligible artist messages to remove artist messages, the filtering based on one or more criteria set for each eligible artist message by a corresponding artist.

14. The computer-readable medium of claim 13, wherein one of the criteria indicates that an artist message is to be presented to a user only when adjacent to a particular media item.

15. The computer-readable medium of claim 10, the steps further comprising:
filtering the eligible artist messages to remove artist messages, the filtering based on a geographic location of the listener.

16. The computer-readable medium of claim 10, the steps further comprising:
filtering the eligible artist messages to remove artist messages, the filtering based on a determination of whether the artist message has been previously provided to the listener within a period of time.

17. The computer-readable medium of claim 10, the steps further comprising:
filtering the eligible artist messages to remove artist messages, the filtering based on a whether a particular media item is to be presented to the listener.

18. The computer-readable medium of claim 10, wherein each artist message comprises:
a call to action comprising a link to be presented to the listener concurrently with the audio recording, the link adapted to perform an action when activated by the listener.
